(19) United States
(12) Patent Application Publication
(10) Pub. No.: US 2024/0242129 A1
(43) Pub. Date: Jul. 18, 2024

(54) SEGMENTED MACHINE LEARNING-BASED MODELING WITH PERIOD-OVER-PERIOD ANALYSIS

(71) Applicant: THE BANK OF NEW YORK MELLON, New York, NY (US)

(72) Inventors: Manish JAIN, Pune (IN); Naren RAMAKRISHNAN, New York, NY (US); Abhishek SINGH, Thane (IN)

(21) Appl. No.: 18/096,243

(22) Filed: Jan. 12, 2023

(51) Int. Cl. G06N 20/20

(52) U.S. Cl. CPC G06N 20/20

(57) ABSTRACT

The disclosure relates to systems and methods of generating behavior classifications that predict a behavior of an entity by training and executing a base machine learning (ML) model, a plurality of segmented ML models, and a merged ML model. Training data may be historical entity data, which may be grouped into different segments that describe the entity. The base ML model may be trained to predict entity behavior across a plurality of segments. Each segmented ML model may be trained to the generate a segmented behavior class that predicts entity behavior based on a respective segment. A system may provide the base class and the plurality of segmented classes as input to a merged model that was trained based on weights for each of the base ML model and the plurality of segmented ML models to generate a behavior classification representing a prediction of the entity behavior.

### BACKGROUND

Trend-based analytics attempt to identify trends in historic or current data to forecast future events. Some machine learning-based models may computationally learn from large datasets to predict future outcomes. In particular, supervised machine learning models may rely on features from data sets that are labeled with known outcomes by subject matter experts. Supervised machine learning may attempt to learn relationships between the labeled features and the known outcomes. Unsupervised machine learning models may attempt to identify features and model the relationships without such curated labels. For example, unsupervised machine learning models may perform probabilistic clustering of underlying data based on their similarities to one another to identify potential features.

However, these and other machine learning-based models may fail to adequately perform trend-based analytics to predict future outcomes by underfitting predictive features in the underlying data and/or by overfitting features that are not as predictive as subject matter experts or probabilistic clustering suggests. For example, underlying data from which features are derived oftentimes have interdependencies on one another. Machine learning-based models may underfit these features because of the presence of other features in the data. Put another way, the vast number of signals in the underlying data may fail to account for a given signal that may be predictive of outcomes. In particular, one feature may have a positive interdependency with another feature that effectively increases their predictive correlation with a target forecast. However, machine learning-based models may under-emphasize (under-weight) these features because they do not account for this enhancing effect. On the other end, certain features may be over-emphasized (over-weighted) if the negative interdependencies are not accounted for. Other issues may include anomalous data that may be overfit, leading to errors. Attempting to mitigate anomalous data through smoothing or normalization may result in too much smoothing, which may also lead to errors. These and other issues exist with machine learning-based modeling to predict future outcomes.

### SUMMARY

Various systems and methods may address the foregoing and other problems. For example, to address the problem of underfitting or overfitting entity data having interdependencies, the system may train and execute multiple machine learning (ML) models using features derived from the entity data. For example, the system may train and use a base ML model using all of the features to generate a predicted outcome across all features. The system may also train and use a plurality of segmented ML models that are each trained only on a subset of the features that are associated with a corresponding segment. For example, each of the features may correspond to a segment from among a plurality of segments. Each of the segments may reflect a particular aspect of the underlying entity data.

To illustrate, an entity's behavior such as attrition will be described. Other types of forecasting may be modeled as well. The entity may be described by one or more categories. Each category may include one or more segments. Thus, a given entity may be categorized into one or more categories and segmented within one or more segments per category. In a computer network context, an entity may be a device in the network. The device may be categorized into various categories such as a device type category, a location category, and/or other categories. The device type category may include different segments that define the device type. For example, segments in this context may include data indicating the device is a router, a switch, an end user device, and so forth. The location category may indicate a location of the device, and be further defined by segments that indicate a location (such as a physical geolocation and/or virtual location) of the device. Thus, a given device entity may be categorized according to a device type category and location category, and be defined by a segments within each category. An example of when a device exhibits attrition may be when it generates fewer responses to requests. In a transactional attrition context, the entity may be a company or individual that is categorized into a revenue category, a location category, and a sector category. The revenue category may include segments “high” “medium” and “low” or other indication of the revenue category to which the entity belongs. The location category may include segments that indicate the location of the entity. The sector category may include segments that indicate the sector in which the entity does business. Thus, the entity in this example may be associated with a particular segment in the revenue category, a particular segment in the location category and a particular segment in the sector category.

Each of the segmented ML models may be trained on one or more features corresponding to a segment. In the foregoing transactional attrition example, a segmented ML model may be trained for each segment in the Region category, each segment in the Location category, and each segment in the Sector category. The system may also train a merged ML model that takes the output of the base ML model and the segmented ML models to generate a behavior classification, which represents a prediction of the behavior of the entity.

If an entity will exhibit attrition, various signals (values in the entity data) in the underlying entity data may be detectable that are correlated with such attrition. For example, certain entity data may show a gradual decline in various data values, which may serve as features for training. The system may learn from these derived features to help the models identify underlying trends in the entity data. Using a merged ML model (a ‘super-model’ approach), the modeling considers all input data sources simultaneously. Thus, the interdependencies between data sources and across segments can be captured. Furthermore, one segment of features may provide mutually reinforcing signals for a given entity. Such dependencies may be captured through the training and use of segmented ML models. For example, a first segmented ML model based on one category and segment may be used to detect attrition, and a second segmented ML model based on another category and segment may be used to detect a pattern or trend that is predictive for attrition, and another model may use outputs of both the first and second segmented ML models. Thus, by using segmented ML models, the system may learn from a diverse variety of combinations of categories and segments, where each segmented ML model may be focused on its specific category and segment and therefore is able to learn trends or other correlations that are specific to that category or segment. Furthermore, training and using multiple models over multiple categories and segments for multiple time periods may result in a merged ML model that learns weights for features, categories, segments, and ultimately for the base ML model and segmented ML models.

To address anomalous data values, the foregoing models may be trained based on different periods of time. For example, labels defining behaviors such as attrition may be based on a short-term attrition and a long-term attrition. An entity may be determined to have exhibited attrition in the past when both the short-term attrition and the long-term attrition definitions have been satisfied. The short-term attrition and/or the long-term attrition definition may define period-over-period (such as month over month) changes over a respective shorter period of time such as three months and a longer period of time such as twelve months. Period-over-period changes may be extended past twelve months in the foregoing example to capture seasonality over the periods of time. Such seasonality may present as anomalies that may be mitigated against by the attrition definitions. Furthermore, the use of both short-term and long-term attrition definitions (or other numbers of attrition definitions) may further mitigate against anomalous data because an anomalous data value is unlikely to affect both (or more definitions). Thus, training the base ML model, the segmented ML models, and the merged models based on labels derived from the attrition definitions may mitigate against anomalous data.

In some examples, the system may determine recent deviations from historical trends to understand how recent data is behaving as compared to the historical trend. For example, the system may determine Z-score deviations for last three months compared to the historical trend to understand current trending.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system for training a base ML model, a plurality of segmented models and a merged ML model and generating a behavior classification based on the trained models, according to an implementation.

FIG. 2 illustrates a schematic example of an attrition definition that defines short-term attrition of an entity for training machine learning-based models, according to an implementation.

FIG. 3 illustrates a schematic example of an attrition definition that defines long-term attrition of an entity for training machine learning-based models, according to an implementation.

FIG. 4 illustrates an example of a flow diagram for training a merged ML model to predict entity behavior based on a base ML model and a plurality of segmented models, according to an implementation.

FIG. 5 illustrates examples of category and segments used for training segment-based models, according to an implementation.

FIG. 6 illustrates an example of a flow diagram for executing a base ML model, a plurality of segmented models, and a merged ML model to generate an entity behavior classification, according to an implementation.

FIG. 7 illustrates an example of a method of training base, segmented, and merged ML models for entity behavior classification, according to an implementation.

FIG. 8 illustrates an example of a method of generating an entity behavior classification, according to an implementation.

FIG. 9 illustrates an example of a method of training base, segmented, and merged ML models and generating an entity behavior classification based on the trained models, according to an implementation.

### DETAILED DESCRIPTION

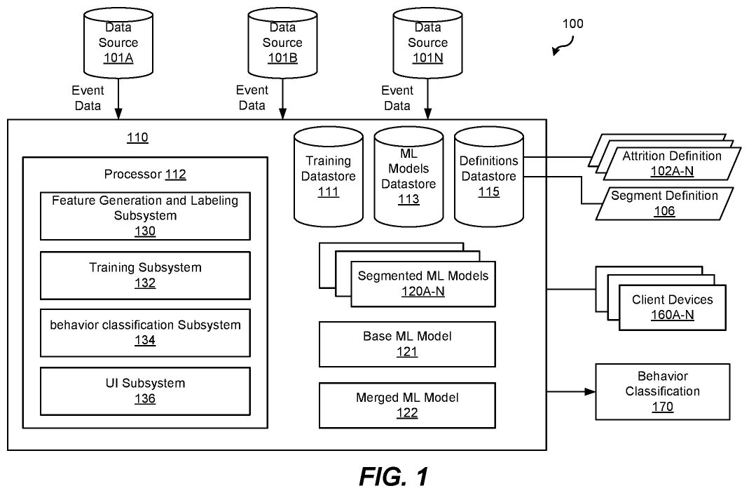

FIG. 1 illustrates an example of a system 100 for training a plurality of segmented models 120, a base ML model 121, and an merged ML model 122 and generating an behavior classification 170 based on the trained models, according to an implementation. As shown in FIG. 1, the system 100 may include one or more data sources 101 (illustrated as data sources 101A-N), a computer system 110, one or more client devices 160 (illustrated as client devices 160A-N), and/or other components.

The behavior classification 170 may include a binary classification that indicates whether or not an entity will exhibit certain behaviors such as attrition. It should be noted that various examples described herein relate to attrition associated with loss of revenue in a transactional context. In these examples, the entity may include legal entities, organizations, individuals, groups, and/or other entities that may be associated with a transactional context. However, the disclosure may be applied to a wide range of contexts. For example, the disclosure may relate to fraud detection in which the use of different segments such as region of an originating transaction, transaction type, and other transaction data may be used to predict whether a transaction is fraudulent. The disclosure may also be applied to transaction fail prediction, attrition in a retail setting, spam classification for cybersecurity, product categorization, customer behavior assessment for promotional offers, image classification in healthcare, supply chain delivery on-time tracking, and/or other contexts in which trending or multiple segments are relevant.

In some examples, the behavior classification 170 is a probability that an entity will exhibit the behavior based on observed entity data relating to the entity. Attrition may refer to a reduction in an activity, such as an average of multiple periods of the activity, of an entity by more than a predefined threshold value. The predefined threshold value may be expressed as a percentage value, an absolute value, and/or other types of values. Attrition may be defined based on one or more configurable attrition definitions 102 (illustrated as attrition definitions 102A-N). Thus, attrition may be defined according to particular needs and particular contexts as specified in the one or more attrition definitions 102.

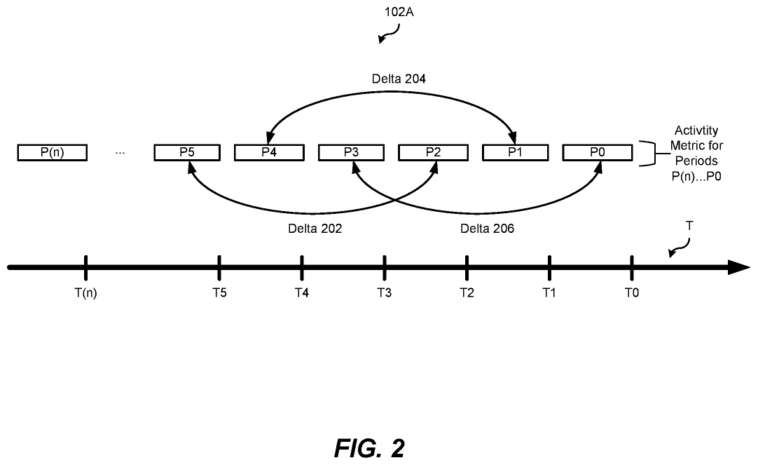

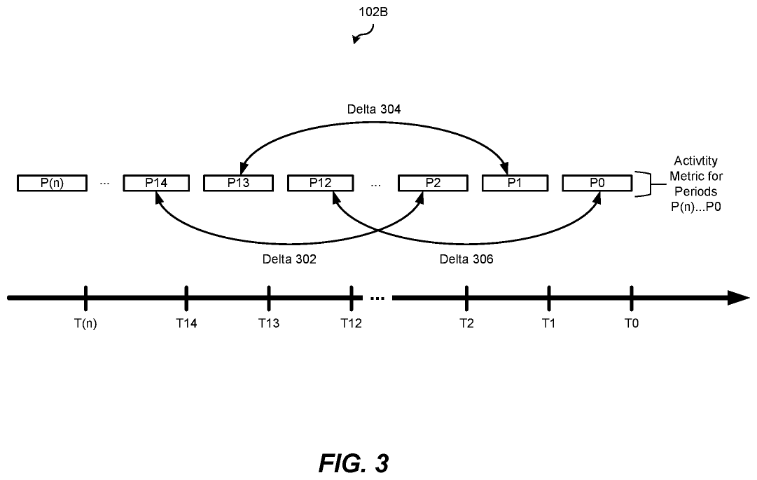

FIGS. 2 and 3 respectively illustrate examples of different attrition definitions 102. For example, FIG. 2 illustrates a schematic example of an attrition definition 102A that defines short-term attrition of an entity for training machine learning-based models, according to an implementation. FIG. 3 illustrates a schematic example of an attrition definition 102B that defines long-term attrition of an entity for training machine learning-based models, according to an implementation.

Attrition may be determined to occur when one or more of the attrition definitions 102 have been met. For example, if both the short-term attrition illustrated in FIG. 2 and the long-term attrition illustrated in FIG. 3 are met, then the entity may be determined to have exhibited attrition over the observed periods. It should be noted that in other examples, only one of the short-term or long-term attrition definitions needs to be met for an entity to be determined to have exhibited attrition. In still other examples, other numbers of attrition definitions 102 may be considered as well.

Referring to FIG. 2, attrition definition 102A defines a short-term attrition illustrated over a timeline (T) with periods of activity (P(n)-P(0)). Each period of activity P may be quantified by a respective activity metric. This activity metric will vary depending on the context in which the system 100 (e.g., as illustrated in FIG. 1) is implemented. For example, for the computer network context, the activity metric may include a number of logon attempts, a number of application requests handled, and/or other metric that quantifies an activity on the computer network during the period of activity P. For a transactional context, the activity metric may include revenue received from the entity during the period of activity P. Additional and/or alternate metrics and/or contexts may be used within the scope of this disclosure. Whichever context is used, each period of activity P may be a configurable length of time, such as, for example, one month.

As illustrated in FIG. 2, to determine short-term attrition, differences between two periods of activity P separated by a short-term may be determined. Short-term refers to a duration of time relative to long-term, meaning that short-term simply refers to a smaller duration of time than long-term, which is illustrated in FIG. 3. For example, short-term may be defined as a quarter, or three months and long-term may be defined as one year, or twelve months.

Delta 202 refers to a difference in activity metric observed in a period of time P5 and a period of time P2, where P5 and P2 are separated by the short-term duration of three months. Delta 204 refers to a difference in activity metric observed in a period of time P4 and a period of time P1, where P4 and P1 are separated by the short-term duration of three months. Delta 206 refers to a difference in activity metric observed in a period of time P3 and a period of time P0, where P3 and P0 are separated by the short-term duration of three months. Other numbers of deltas and/or other short-term durations may be used as well or instead. Each of the deltas 202, 204, and 206 may be expressed as a percentage difference, an absolute numeric difference, and/or other quantitative or qualitative difference. For example, in a computer network context, the percentage difference may relate to a percentage decrease (or increase) in number of requests handled by an entity (such as device) in a computer network between compared periods of time P. In a transactional context, the percentage difference may relate to a percentage decrease (or increase) in revenue received from the entity between compared periods of time P.

An activity metric may be determined based on the deltas 202, 204, and 206. For example, the activity metric may be based on an average of the deltas 202, 204, and 206. The average may be compared to a threshold value. If the activity metric meets or exceeds the threshold value, then the activity metric may be deemed to have satisfied the attrition definition (in this case, attrition definition 102A). In some examples, the threshold value may be different for different segments. For example, the threshold value may be 10% difference for High and Medium segments in the Revenue category and 20% difference for Low segment in the Revenue category. Other thresholds may be used for other categories and segments. In some examples, a single threshold value may be used for all segments in a given category. The threshold values may be configured based on particular implementations and contexts. Generally speaking, threshold values may range between about 5% difference and 20% difference. Although other ranges and threshold values may be used.

Referring to FIG. 3, the deltas 302, 304, and 306 are determined similar to how 202, 204, and 206 are determined in FIG. 2, except that the duration of time between compared periods of activity P are longer between the deltas 302, 304, and 306. For example, in FIG. 3, the duration of time may be one year (twelve months) versus one quarter (three months) illustrated in FIG. 2.

It should be noted that the period of activity P, and duration of “short-term” and “long-term” may be configured according to particular needs. For example, a period of activity P may instead be defined as a day, a week, or other length of time. Likewise, “short-term” may be defined as a day, a week, or other length of time, so long as the short-term length of time is less than “long-term”, which may similarly be any length of time. In some examples, an attrition definition 102 may define attrition based on a comparison of 3 months compared with 3 months of a previous quarter. In some examples, an attrition definition 102 may define attrition based on a comparison of 3 months compared with 3 months of the previous year. The approach calculates short-term attrition as well as long term attrition. Adding both behaviors and considering multiple months, takes care of seasonality factors as well as any anomalies in the data. Attrition as defined may be used to label training data for machine learning-based modeling to predict attrition.

### Training and Using Machine Learning-Based Models to Predict Attrition

For example, the computer system 110 may train and execute machine learning-based models to predict attrition. The computer system 110 may include one or more processors 112, a training datastore 111, a machine learning models datastore 113 (referred to as “ML models datastore 113”), a definitions datastore 115, and/or other components. The processor 112 may include one or more of a digital processor, an analog processor, a digital circuit designed to process information, an analog circuit designed to process information, a state machine, and/or other mechanisms for electronically processing information. Although processor 112 is shown in FIG. 1 as a single entity, this is for illustrative purposes only. In some embodiments, processor 112 may comprise a plurality of processing units. These processing units may be physically located within the same device, or processor 112 may represent processing functionality of a plurality of devices operating in coordination.

As shown in FIG. 1, processor 112 is programmed to execute one or more computer program components. The computer program components may include software programs and/or algorithms coded and/or otherwise embedded in processor 112, for example. The one or more computer program components or features may include a feature generation and labeling subsystem 130, training subsystem 132, an behavior classification subsystem 134, a UI subsystem 136, and/or other components or functionality.

### Feature Generation, Selection and Labeling

The feature generation and labeling subsystem 130 may generate features for training by transforming entity data from one or more data sources 101. For example, entity data relating to entities may be provided by respective data sources 101. The entity data may describe an event relating to the entity that occurred at a particular event time. “Event time” refers to a date and/or time that the event occurred or was recorded. The value of the entity data may be translated into one or more features that are used to train machine learning-based models described herein for predicting the activity of the entity. The specific type of entity data and specific type of activity may vary depending on the context in which the system 100 is implemented.

For example, in a computer network activity context, the entity data may refer to events that pertain to a computer network of the entity such as logon attempts, network requests, and/or other activity detected in the computer network. In this example, the activity may relate to an attrition based on a reduction of network-related activity, which may indicate a potential problem such as a faulty device or service in the computer network. In another example, in transactional activity contexts, the entity data may refer to events that pertain to the entity's transactional activity such as fund transfers to or from accounts and/or other transactional activity of the entity. In this example, the activity may relate to an attrition based on reduction of revenue received from the entity.

In a network security context, attrition may relate to a number of successful transactions or requests handled by a computer network, application service, software as a service, network as a service, or other computer or network activity that may be monitored in the computer network. In a transactional context, attrition may relate to a decline in revenue from the entity.

In some examples, each entity may be described by one or more categories. Each category may include one or more segments. Thus, a given entity may be categorized into one or more categories and segmented within one or more segments per category. For example, in the computer network attrition example, an entity may be a device in the network. The device may be categorized into various categories such as a device type category, a location category, and/or other categories. The device type category may include different segments that define the device type. For example, segments in this context may include data indicating the device is a router, a switch, an end user device, and so forth. The location category may indicate a location of the device, and be further defined by segments that indicate a location (such as a physical geolocation and/or virtual location) of the device. Thus, a given device entity may be categorized according to a device type category and location category, and be defined by a segments within each category.

In the transactional attrition example, the entity may be a company or individual that is categorized into a revenue category, a location category, and a sector category. The revenue category may include segments “high” “medium” and “low” or other indication of the revenue category to which the entity belongs. The location category may include segments that indicate the location of the entity. The sector category may include segments that indicate the sector in which the entity does business. Thus, the entity in this example may be associated with a particular segment in the revenue category, a particular segment in the location category and a particular segment in the sector category. The categories and segments may be defined by the segment definitions 106, which may be stored in the definitions datastore 115.

Regardless of the context in which entity behavior is modeled, segments may have interdependencies that may be complementary or non-complementary to one another. Such complementarity (or non-complementarity) may not be detectable using ordinary machine learning approaches. To address this issue, the system 100 may train and use a base ML model 121, a plurality of segmented machine learning models 120A-N, and a merged ML model 122 trained on the outputs of the other models to generate an behavior classification 170. The data used for training the models may be segmented in a way that captures any interdependencies and other network effects that may exist in the training data. In this way, the system may be able to detect and learn from interdependencies in the entity data and/or learn individually from each of the segments of entity data.

Table 1 shows examples of entity data in the transactional context example.

Sum/Average of Daily End of Day (EOD) balance (average over month)
amount from 2 Balance Applications
Standard deviation of Monthly EOD average balance amount from 2
Balance Applications
Total Payments and Deposit amount from 3 Payment Systems
Total Deposit amount from 3 Payment Systems
Total Payments amount from 3 Payment Systems
Annual Price hike
Total number of breaches/Exposure in Liquidity system
FX Revenue and FX Activity
Sum/Average of Daily End of Day (EOD) balance (average over month)
amount from 2 Balance Applications

Table 2 shows examples of features that are engineered from entity data and corresponding transformations.

| Feature type | Entity data | Transformation |
|---|---|---|
| MoM (month | payments, balances, | Difference in monthly values |
| over month) | credit usage, product | (current value − Pth value) |
| changes | usage (It is the total | where P in (last month, last |
| | number of Treasury | to last month, . . . ) per client |
| | Products used by | (x[current] − x[past])/x[past] |
| | Client) | |
| QoQ (quarter | payments, balances, | Difference in quarterly values |
| over quarter) | credit usage, product | (current value − Pth value) |
| changes | usage, | where P in (last quarter, last |
| | | to last quarter) per client |
| | | x = np.array(x) |
| | | current = x[−3:].sum( ) |
| | | past = x[−3*(quarter + |
| | | 1):−3*quarter].sum( ) |
| | | (current − past)/past |
| Average of | payments, balances, | Average of deviations of last |
| last 3 months | credit usage, product | 3 monthly values with regard |
| Z-score | usage, | to mean values per client |
| deviations | | mean = x[:−3].mean( ) |
| | | std = x[:−3].std( ) |
| | | z1, z2, z3 = (x[−1] − mean)/std, |
| | | (x[−2] − mean)/std, |
| | | (x[−3] − mean)/std |
| | | avg z-score = np.mean([z1, z2, |
| | | z3]) |

Features may be prone to various errors introduced by sampling, human data input errors, or other sources of error in the entity data or during feature generation. In some examples, features may be normalized based on Z-score normalization, which normalizes error in features by dividing the difference between the data and mean by standard deviation. In other examples, data may be normalized based on feature scaling, which brings all values into a range such as between 0 and 1 by dividing the difference between the data and minimum by the difference between maximum and minimum. Other normalization techniques may be used as well or instead, such as studentized residual, t-statistics, and coefficient of variation.

The feature generation and labeling subsystem 130 may use features that were optimized during a feature selection process. Feature selection refers to a process that filters in or out features to generate a filtered feature set. Examples of feature selection may include stepwise feature selection, backward elimination, forward selection, stepwise regression, lasso and ridge regression, dimensionality regression, principal component analysis, and/or other feature selection methods.

The filtered feature set may include a subset of the features. Feature selection may therefore reduce the number of features used in one or more of the trained models. The feature selection process may optimize model performance. Feature selection may reduce noise and overfitting since different sensor data and different features derived from the sensor data may have different predictive impact. In some examples, the top N features may be identified by feature selection, where N is an integer. This may be used to identify the greatest signals that are most highly correlated with accurate predictions.

The feature generation and labeling subsystem 130 may generate and select features for training. For example, the feature generation and labeling subsystem 130 may access historical entity data that is to serve as a training dataset. The historical entity data may be associated with entities that are known to have exhibited behavior such as attrition. Thus, this historical entity data may serve as a basis to train machine learning-based models to learn features that correlate with the known behavior. As such, the feature generation and labeling subsystem 130 may use the historical entity data to generate and select features from the historical entity data.

The feature generation and labeling subsystem 130 may associate the generated and selected features with a label indicating the behavior. For example, a determination of attrition based on one or more attrition definitions 102 may be used as a label for learning features that caused the observed attrition.

For binary classifications, the label may be a binary label such as 1 or 0, where one of the binary labels indicates attrition was observed for the feature and the other binary label indicates no attrition was observed for the feature. For multi-class classifications, each label, from among a number of labels greater than two, may indicate a respective class. The labels and feature sets may be store in the training datastore 111.

### Training Phase

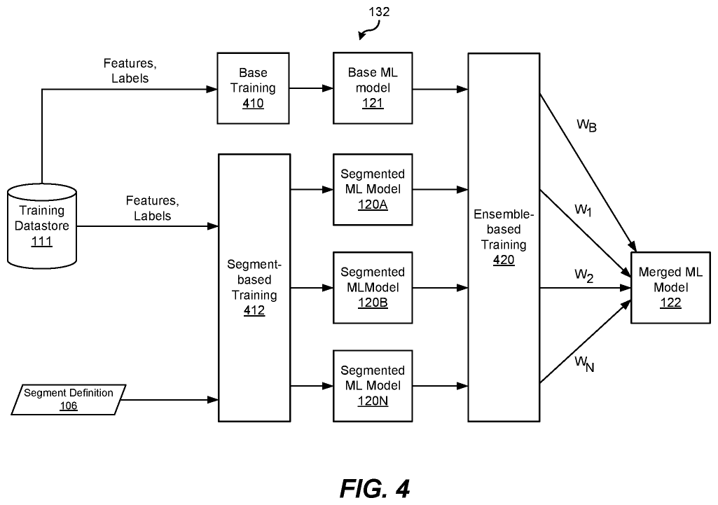

The training subsystem 132 may train a base ML model 121, one more segmented ML models 120, and a merged ML model 122 to perform classification tasks to predict whether an entity will exhibit a behavior of interest, such as attrition in various contexts. Referring to FIG. 4, the training subsystem 132 may access the training datastore 111 to obtain features and labels generated by the feature generation and labeling subsystem 130. The training subsystem 132 may perform base training 410 to train a base ML model 121 and segment-based training 412 to train a plurality of segmented ML models 120.

Base training 410 and segment-based training 412 may each use machine learning techniques for training the respective models. For example, base training 410 and/or segment-based training 412 may use gradient boosting. Gradient boosting is a machine learning technique for regression and classification problems, which produces a prediction model in the form of an ensemble of prediction models, which may be decision trees. Gradient Boosting Machines (GBM) such as XGBoost, LightGBM, or CatBoost. may build a model in a stage-wise fashion and generalize the model by allowing optimization of an arbitrary differentiable loss function. GBM may operate on categories/sub-categories of features, making it suited for the feature sets described herein. Segmented modeling may further permit discovery of interdependencies in the data.

Other machine learning techniques may be used as well, such as neural networks. A neural network, such as a recursive neural network, may refer to a computational learning system that uses a network of neurons to translate a data input of one form into a desired output. A neuron may refer to an electronic processing node implemented as a computer function, such as one or more computations. The neurons of the neural network may be arranged into layers. Each neuron of a layer may receive as input a raw value, apply a classifier weight to the raw value, and generate an output via an activation function. The activation function may include a log-sigmoid function, hyperbolic tangent, Heaviside, Gaussian, SoftMax function and/or other types of activation functions.

The machine learning techniques may employ regression and/or classification depending on particular implementations. In supervised learning, machine learning is employed to learn the mapping function from the input variable (x) (such as features) to an output variable (y) (such as a known behavior such as attrition associated with those features). The learning objective is to approximate a mapping function (f) as accurately as possible such that whenever there is a new input data (x), the output variable (y) for the dataset can be predicted.

Regression techniques may generate numerical (or continuous) outputs while classification may generate categorical (or discrete) classes. Thus, regression techniques may be used for open-ended outputs while classification may be used for discrete classes (such as attrition or no attrition).

### Base, Segmented, and Ensemble Training

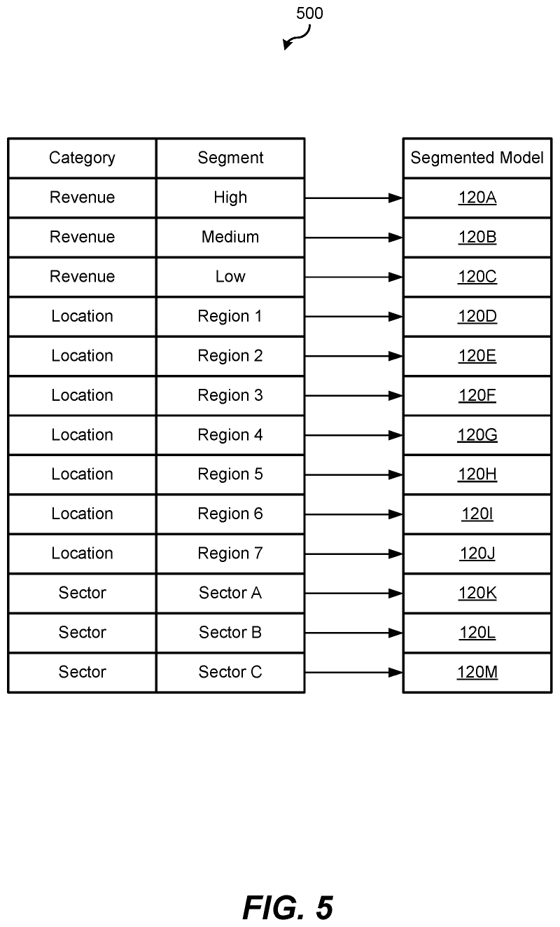

Base training 410 may use the training dataset (features and labels) to train the base ML model 121 without respect to segmented data. On the other hand, segment-based training 412 access a segment definition 106 and group the training dataset into segmented data using categories and segments defined by the segment definition 106. Segment-based training 412 may train each segmented ML model 120 based on the segmented data corresponding to each segment. As such, each segmented ML model 120 is able to better learn the characteristics of a corresponding segment. When ensembled with multiple models, the models together collectively may better fit the data since signals across segments are more thoroughly learned during segment-based training 412. In the example illustrated in FIG. 5, there are three categories of data that describe entities for which the underlying entity data relate: Revenue, Location, and Sector. As illustrated, the Revenue category has three segments of data: High, Medium, and Low. The Location category has seven segments of data: Regions 1-7. The Sector category has three segments of data: Sectors A-C. Other numbers of categories and their segments may be used as well or instead. Furthermore, the particular type of categories and their segments will vary depending on the type of entity data being modeled. For example, the categories and their segments may differ for computer network and other contexts.

In the illustrated example, segment-based training 412 may train thirteen segmented ML models 120A-M each corresponding to a respective segment. In some examples, within each category, training will be performed without data from that category. For example, segmented models 120A-C may each be trained based on all features (across all columns) but only data rows that correspond to the particular segment. For example, segmented model 120A may be trained based on all features (across all columns) but only data rows that correspond to the High revenue segment. Segmented model 120B may be trained based on all features (across all columns) but only data rows that correspond to the Medium revenue segment. Segmented model 120C may be trained based on all features (across all columns) but only data rows that correspond to the Low revenue segment. Segmented models 120D-J and 120K-M may each be trained similarly according to their respective category and segment. In this way, each of the segmented models 120 to learn from these interdependencies without its own category of data, which permits learning from interdependencies between categories of data, effectively enhancing these signals of data.

Each entity in the training dataset may belong to one of each category and a segment in each category. For example, a first entity may be associated with Revenue: High, Location: Region 2, and Sector: Sector B. A second entity may be associated with Revenue: High, Location: Region 7, and Sector: Sector A. A third entity may be associated with Revenue: Low, Location: Region 3, and Sector: Sector A, and so forth.

Appropriate segmented ML models 120 will be executed for each entity depending on their category and segment associations. For example, segmented ML models 120A, 120E, and 120L will be executed during the execution phase for the first entity. Segmented ML models 120A, 120J, and 120K will be executed during the execution phase for the second entity. Segmented ML models 120C, 120F, and 120K will be executed during the execution phase for the second entity. Other segmented ML models 120 be similarly executed for other entities based on their corresponding category and segments. The base ML model 121 will also executed for each entity. In this example, each entity will have execution of four models: the base ML model 121 at a given time of execution.

Returning to FIG. 4, each of the base ML model 121 and segmented ML models 120 will output a respective classification, which may include a binary label corresponding to attrition or no attrition and/or a probability that supports a binary label. The probability output may indicate a likelihood that the entity will attrite (exhibit attrition). Ensemble-based training 420 may take the outputs of the base ML model 121 and segmented ML models 120 and generate a weight for each model. For example, ensemble-based training 420 may assigned weight W_{B} to the base ML model 121 and weights W_{1-N} to respective ones of each segmented ML model 120A-N. To do so, ensemble-based training 420 may access further training data corresponding to known attrition of the entities and generate the weights based on the performance of each of the base ML model 121 and segmented ML models 120 to train an merged ML model 122. The merged ML model 122 represents the weighted output of the base ML model 121 and segmented ML models 120A-N.

### Ensemble-Based Training

Ensemble-based training 420 may combine the predictions of the base ML model 121 and segmented ML models 120. Examples of ensemble learning may include are bagging, stacking, boosting, and/or other ensemble learning that combines outputs of multiple models. Bagging may include fitting decision trees on different samples of the same dataset and averaging the predictions. Stacking may include fitting many different model types on the same data and using another model to learn how to combine the predictions. Boosting may include adding merged ML models sequentially that correct the predictions made by prior models and outputs a weighted average of the predictions.

In some examples, the base training 410 and segment-based training 412 may train their respective models over a training period having training intervals. For example, the base training 410 and segment-based training 412 may train their respective models over a nine-month period in monthly intervals. In this example, base training 410 and segment-based training 412 may train their respective models nine times over the nine-month period. Each entity may therefore have nine sets of predictions from the base ML model 121 and the segmented ML models 120. These nine sets of predictions per entity may be used to determine the weighted output during ensemble-based training 420. Other training periods and training intervals may be used as well or instead.

For example, if a particular model generated an attrition classification label of 1 for a particular entity, indicating predicted attrition, but the ensembled-based training 420 observed no attrition by the particular entity, then the particular model may be assigned a lower weight. In some examples, each of the nine (or other time interval) model outputs may be assessed individually for weighting purposes. In other examples, the nine interval model outputs may be assessed together by averaging their probability outputs to generate an averaged label.

Once trained, the base ML model 121, the segmented ML models 120A-N, and the merged ML model 122 may be stored in the ML models datastore 113. For example, the model parameters, model weights, and/or other data relating to these trained models may be stored in the ML models datastore 103 along with model identifiers for each trained model. The entity data and their associated features and labels may be stored in the training datastore 111.

### Execution/Prediction Phase

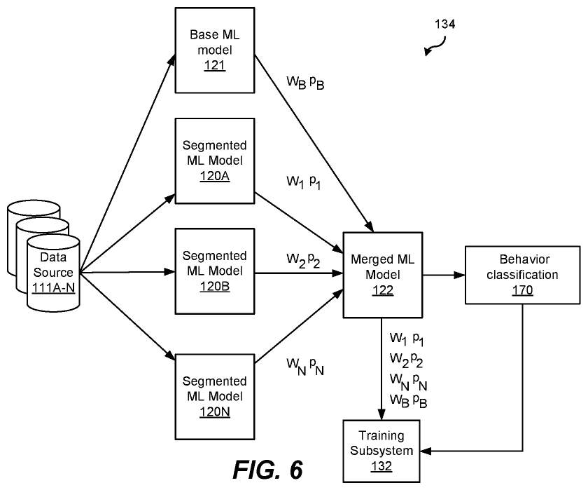

In operation, the computer system 110 may execute the trained models to generate a behavior classification 170 for a particular entity based on incoming (such as current) entity data relating to the entity. For example, referring to FIG. 6, the behavior classification subsystem 134 may obtain entity data from a data source 101A-N. The entity data may include current data relating to an entity for which attrition is to be predicted. The entity data may be converted into features and input to the base ML model 121 and the relevant segmented models 120, where such relevant segmented models 120 may be identified based on one or more segments associated with the entity. Examples of segments associated with the entity were described in FIG. 4. The merged ML model 122 may use weighted probabilities (W_{B}P_{B}, W_{1-N} P_{1-N}) of each of the base ML model 121 and the relevant segmented models 120 and generate a behavior classification 170. For example, an overall probability may be generated based on the weighted probabilities. The overall probability may be generated by the merged ML model 122 based on an ensemble approach for training the merged ML model 122. The behavior classification 170 may be based on the overall probability. For example, the overall probability may be compared to a threshold value. If the overall probability exceeds (and/or meets) the threshold value, the entity may be predicted to attrite. It should be noted that this is the case if the overall probability relates to a probability of attrition.

In some examples, the weighted probabilities may be fed back to the training subsystem 132 for re-training the base ML model 121, the relevant segmented models 120, and/or the merged ML model 122. For example, the weighted probabilities may later be associated with observed outcomes of entity attrition (as determined from feedback from a human user or automated process for identifying actual attrition) and added to the training dataset for updated training.

The UI subsystem 136 may provide an indication of the behavior classification 170 via a user interface. Furthermore, in some implementations, the UI subsystem 136 may generate an interface that includes the top M likely entities to attrite based on the outputs of the models described herein, where M is a configurable integer. In some examples, the UI subsystem 136 may generate an interface that includes the top N signals in the entity data, where N is a configurable integer. The top N signals may represent the entity data and/or features that are most predictive of known attrition or other target behaviors.

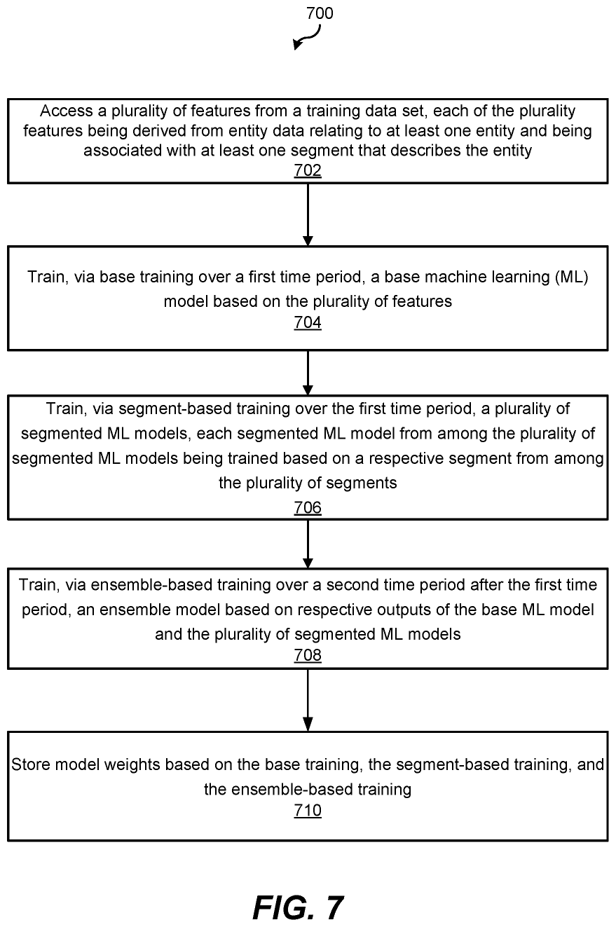

FIG. 7 illustrates an example of a method 700 of training base, segmented, and merged ML models for entity behavior classification, according to an implementation. At 702, the method 700 may include accessing a plurality of features from a training data set, each of the plurality features being derived from entity data relating to at least one entity and being associated with at least one segment from among a plurality of segments that is associated with the at least one entity. The plurality of features may have been generated by the feature generation and labeling subsystem 130. Examples of segments are described at FIGS. 4 and 5.

At 704, the method 700 may include training, via base training (such as base training 410) over a first time period, a base machine learning (ML) model (such as base ML model 121) based on the plurality of features.

At 706, the method 700 may include training, via segment-based training (such as segment-based training 412) over the first time period, a plurality of segmented ML models (such as segmented ML models 120), each segmented ML model from among the plurality of segmented ML models being trained based on a respective segment from among the plurality of segments.

At 708, the method 700 may include training, via an ensemble-based training (such as ensemble-based training 420) over a second time period after the first time period, a merged ML model (such as merged ML model 122) based on respective outputs of the base ML model and the plurality of segmented ML models.

At 710, the method 700 may include storing model weights based on the base training, the segment-based training, and the ensemble-based training. For example, the model weights and/or other modeling data may be stored in the training datastore 111.

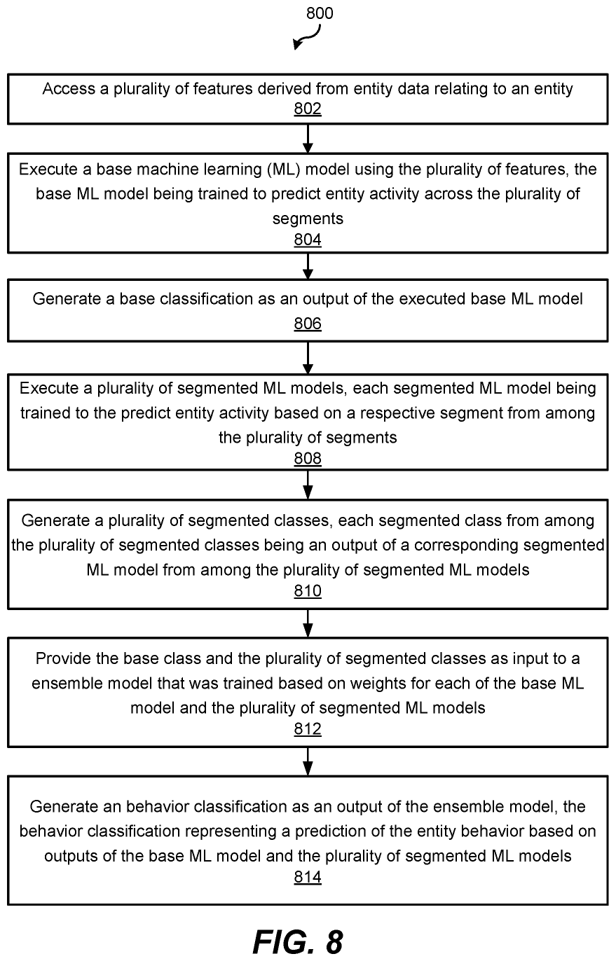

FIG. 8 illustrates an example of a method 800 of generating an entity behavior classification, according to an implementation.

At 802, the method 800 may include accessing a plurality of features derived from entity data relating to an entity. The features may have been generated by the feature generation and labeling subsystem 130. The entity (and corresponding entity data) may be associated with a plurality of segments, such as the segments described in FIGS. 4 and 5.

At 804, the method 800 may include executing a base ML model (such as the base ML model 121) using the plurality of features, the base ML model being trained to predict entity behavior across the plurality of segments.

At 806, the method 800 may include generating a base classification as an output of the executed base ML model.

At 808, the method 800 may include executing a plurality of segmented ML models (such as segmented ML models 120), each segmented ML model being trained to the predict entity behavior based on a respective segment from among the plurality of segments.

At 810, the method 800 may include generating a plurality of segmented classes, each segmented class from among the plurality of segmented classes being an output of a corresponding segmented ML model from among the plurality of segmented ML models. Each segmented class may represent a prediction by a respective segmented ML model 120 that an entity will, such as a probability that an entity will exhibit a behavior of interest such as attrition.

At 812, the method 800 may include providing the base class and the plurality of segmented classes as input to a merged ML model (such as merged ML model 122) that was trained based on weights for each of the base ML model and the plurality of segmented ML models.

At 814, the method 800 may include generating a behavior classification (such as behavior classification 170) as an output of the merged ML model, the behavior classification representing a prediction of the entity behavior based on outputs of the base ML model and the plurality of segmented ML models.

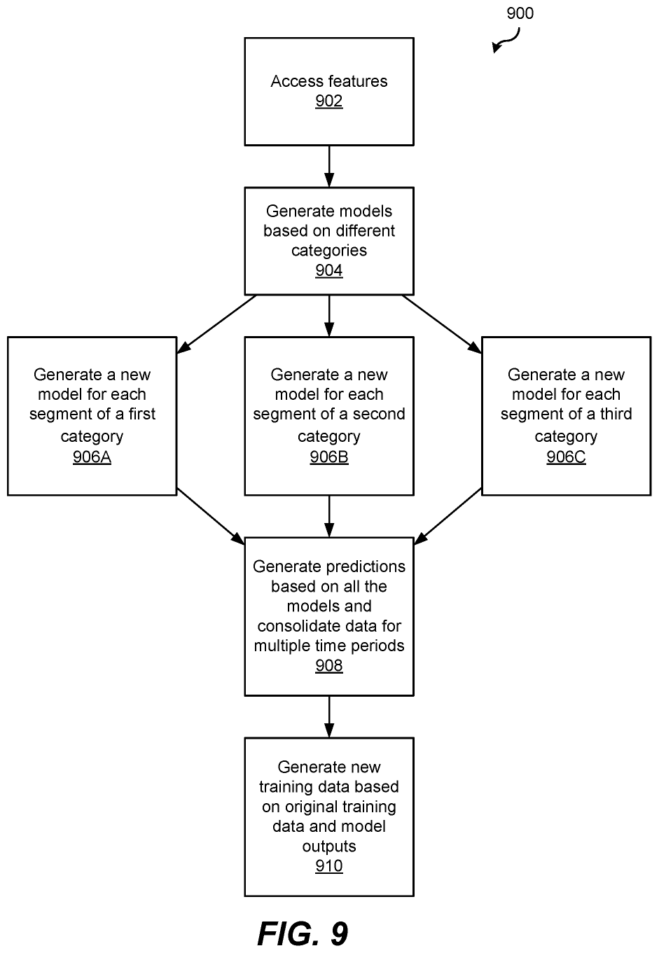

FIG. 9 illustrates an example of a method 900 of training base, segmented, and merged ML models and generating an entity behavior classification based on the trained models, according to an implementation. At 902, the method 900 may include accessing features, which may be derived from entity data and generated by feature generation and labeling subsystem 130. At 904, the method 900 may include generating models based on different categories. At 906A, 906B, and 906C, the method 900 may include respectively generating a new model for each segment of a first category, a new model for each segment of a second category, and a third model for each segment of a third category. To illustrate, in the transactional context example, a first category may relate to a Revenue category with revenue segments: High, Medium, and Low. In this example, a new model may be generated based on training using all features (in all columns) but data only for rows that relate to High revenue (Since Revenue column values are all same, this may not be used for training the new model). Another new model may be generated based on training using all features (in all columns) but data only for rows that relate to Medium revenue. Another new model may be generated based on training using all features (in all columns) but data only for rows that relate to Low revenue. Collectively, in this example, a set of three first new models for the Revenue category may be trained corresponding to High, Medium, and Low revenue segments. Other new models (sets of one or more new models) may be similarly trained for other categories (such as at 906B and 906C). At 908, the method 900 may include generating predictions based on all the models and consolidate data for multiple time periods, such as months. At 910, the method 900 may include generating new training data based on original training data and model outputs to retrain the models.

Processor 112 may be configured to execute or implement 130, 132, 134, and 136 by software; hardware; firmware; some combination of software, hardware, and/or firmware; and/or other mechanisms for configuring processing capabilities on processor 112. It should be appreciated that although 130, 132, 134, and 136 are illustrated in FIG. 1 as being co-located in the computer system 110, one or more of the components or features 130, 132, 134, and 136 may be located remotely from the other components or features. The description of the functionality provided by the different components or features 130, 132, 134, and 136 described below is for illustrative purposes, and is not intended to be limiting, as any of the components or features 130, 132, 134, and 136 may provide more or less functionality than is described, which is not to imply that other descriptions are limiting. For example, one or more of the components or features 130, 132, 134, and 136 may be eliminated, and some or all of its functionality may be provided by others of the components or features 130, 132, 134, and 136, again which is not to imply that other descriptions are limiting. As another example, processor 112 may include one or more additional components that may perform some or all of the functionality attributed below to one of the components or features 130, 132, 134, and 136.

The datastores (such as 111, 113, 115) may be a database, which may include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The datastores may include cloud-based storage solutions. The database may store a plurality of types of data and/or files and associated data or file descriptions, administrative information, or any other data. The various datastores may store predefined and/or customized data described herein.

Each of the computer system 110 and client devices 160 may also include memory in the form of electronic storage. The electronic storage may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionalities described herein.

The computer system 110 and the one or more client devices 160 may be connected to one another via a communication network (not illustrated), such as the Internet or the Internet in combination with various other networks, like local area networks, cellular networks, or personal area networks, internal organizational networks, and/or other networks. It should be noted that the computer system 110 may transmit data, via the communication network, conveying the predictions one or more of the client devices 160. The data conveying the predictions may be a user interface generated for display at the one or more client devices 160, one or more messages transmitted to the one or more client devices 160, and/or other types of data for transmission. Although not shown, the one or more client devices 160 may each include one or more processors, such as processor 112.

The systems and processes are not limited to the specific implementations described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system features illustrated in FIGS. 1, 4 and 6.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for identifying activity classes of entities using machine learning, comprising:
a processor programmed to:
access a plurality of features derived from entity data relating to an entity, the entity being associated with a plurality of segments;
execute a base machine learning (ML) model using the plurality of features, the base ML model being trained to predict entity behavior across the plurality of segments;
generate a base classification as an output of the executed base ML model;
execute a plurality of segmented ML models, each segmented ML model being trained to the predict entity behavior based on a respective segment from among the plurality of segments;
generate a plurality of segmented classes, each segmented class from among the plurality of segmented classes being an output of a corresponding segmented ML model from among the plurality of segmented ML models;
provide the base class and the plurality of segmented classes as input to a merged model that was trained based on weights for each of the base ML model and the plurality of segmented ML models; and
generate a behavior classification as an output of the merged model, the behavior classification representing a prediction of the entity behavior based on outputs of the base ML model and the plurality of segmented ML models.

2. The system of claim 1, wherein the processor is further programmed to:
identify one or more segments associated with the entity; and
select corresponding ones of the plurality of segmented ML models to execute for the entity based on the identified one or more segments.

3. The system of claim 1, wherein the plurality of segmented ML models are each trained based on different period-over-period changes in the entity data over time that define a trend.

4. The system of claim 3, wherein the different period-over-period changes comprises a first period and a second period longer than the first period.

5. The system of claim 1, wherein the entity behavior is labeled for training the base ML model and the plurality of segmented ML models based on a first definition that specifies activity of the entity that defines the entity behavior over a first time period and a second specifies activity of the entity that defines the entity behavior over a second time period greater than the first time period.

6. The system of claim 5, wherein the entity behavior is labeled for training only when both the first definition and the second definition are satisfied.

7. The system of claim 1, wherein the merged model is based on a weight applied to each of: the base ML model and the plurality of segmented ML models.

8. The system of claim 1, wherein the processor is further programmed to:
provide outputs of the base ML model, the plurality of segmented ML models and the merged ML model to a training subsystem to retrain one or more of the models.

9. A method for identifying activity classes of entities using machine learning, comprising:
accessing, by a processor, a plurality of features derived from entity data relating to an entity, the entity being associated with a plurality of segments;
executing, by the processor, a base machine learning (ML) model using the plurality of features, the base ML model being trained to predict entity behavior across the plurality of segments;
generating, by the processor, a base classification as an output of the executed base ML model;
executing, by the processor, a plurality of segmented ML models, each segmented ML model being trained to the predict entity behavior based on a respective segment from among the plurality of segments;
generating, by the processor, a plurality of segmented classes, each segmented class from among the plurality of segmented classes being an output of a corresponding segmented ML model from among the plurality of segmented ML models;
providing, by the processor, the base class and the plurality of segmented classes as input to a merged model that was trained based on weights for each of the base ML model and the plurality of segmented ML models; and
generating, by the processor, a behavior classification as an output of the merged model, the behavior classification representing a prediction of the entity behavior based on outputs of the base ML model and the plurality of segmented ML models.

10. The method of claim 9, further comprising:
identifying one or more segments associated with the entity; and
selecting corresponding ones of the plurality of segmented ML models to execute for the entity based on the identified one or more segments.

11. The method of claim 9, wherein the plurality of segmented ML models are each trained based on different period-over-period changes in the entity data over time that define a trend.

12. The method of claim 11, wherein the different period-over-period changes comprises a first period and a second period longer than the first period.

13. The method of claim 10, wherein the entity behavior is labeled for training the base ML model and the plurality of segmented ML models based on a first definition that specifies activity of the entity that defines the entity behavior over a first time period and a second specifies activity of the entity that defines the entity behavior over a second time period greater than the first time period.

14. The method of claim 13, wherein the entity behavior is labeled for training only when both the first definition and the second definition are satisfied.

15. The method of claim 9, wherein the merged model is based on a weight applied to each of: the base ML model and the plurality of segmented ML models.

16. The method of claim 9, further comprising:
providing outputs of the base ML model, the plurality of segmented ML models and the merged ML model to a training subsystem to retrain one or more of the models.

17. The method of claim 9, further comprising:
identifying a subset of the plurality of features based on their predictiveness of the entity behavior; and
providing the subset for display.

18. A non-transitory computer readable medium storing instructions that, when executed by a processor, programs the processor to:
access a plurality of features from a training data set, each of the plurality features being derived from entity data relating to at least one entity and being associated with at least one segment from among a plurality of segments that is associated with the at least one entity;
train, via base training over a first time period, a base machine learning (ML) model based on the plurality of features;
train, via segment-based training over the first time period, a plurality of segmented ML models, each segmented ML model from among the plurality of segmented ML models trained based on a respective segment from among the plurality of segments;
train, via an ensemble-based training over a second time period after the first time period, a merged model based on respective outputs of the base ML model and the plurality of segmented ML models; and
store model weights based on the base training, the segment-based training, and the ensemble-based training.

19. The non-transitory computer readable medium of claim 18, wherein the base ML model and the plurality of segmented models are trained to predict an entity behavior, and wherein the entity behavior is labeled for training the base ML model and the plurality of segmented ML models based on a first definition that specifies activity of the entity that defines the entity behavior over a first time period and a second specifies activity of the entity that defines the entity behavior over a second time period greater than the first time period.

20. The non-transitory computer readable medium of claim 19, wherein the entity behavior comprises an attrition of an activity of the entity.
